(19) United States
(12) Patent Application Publication
(10) Pub. No.: US 2009/0191034 A1
(43) Pub. Date: Jul. 30, 2009

(54) REMOTE CONTROLLABLE MATERIAL HANDLING SYSTEM

(75) Inventors: Scott McGhee, Rosedale (CA); Gary Teichrob, Chilliwack (CA); James Easden, Chilliwack (CA)

Correspondence Address: DLA PIPER LLP (US), 4365 EXECUTIVE DRIVE, SUITE 1100, SAN DIEGO, CA, 92121-2133, US

(73) Assignee: Ty-Crop Manufacturing Ltd., Rosedale (CA)

(21) Appl. No.: 12/343,225

(22) Filed: Dec. 23, 2008

Related U.S. Application Data
(60) Provisional application No. 61/017,153, filed on Dec. 27, 2007.
(60) Provisional application No. 61/022,764, filed on Jan. 22, 2008.

(51) Int. Cl. B65G 67/00; G05D 3/00

(52) U.S. Cl. 414/373; 701/2

(57) ABSTRACT

The remote controllable material handling system comprises a material handling device configured to carry particulate matter, which includes one or more operatively coupled actuators, wherein the actuators are configured to transfer the particulate matter carried by the material handling device and are responsive to one or more control signals. The remote controllable material handling system further includes a MHD receiver operatively connected to the material handling device, which is configured to generate the one or more control signals in response to one or more transmission signals originating from a wireless remote transmitter. The wireless remote transmitter is moveable relative to the material handling device, and configured to receive as input one or more operator instructions for generating the one or more transmission signals for transmission to the MHD receiver in response to the one or more operator instructions.

### RELATED APPLICATIONS

This application claims priority under 35 U.S.C. § 119(e) of U.S. Provisional applications, Ser. Nos. 61/017,153 filed Dec. 27, 2007 and 61/022,764 filed Jan. 22, 2008, each of which is hereby incorporated by reference in its entirety.

### FIELD OF THE INVENTION

The present invention pertains to particulate material handling systems and more particularly to the remote control of such systems.

### BACKGROUND

For material handling, the land management industry provides equipment capable of the transportation and controlled delivery of particulate matter, for example, granular or mixed material, to multiple locations. This is typically achieved through the use of towed vehicles that are equipped with hoppers for holding the material until disposition. U.S. Pat. No. 6,202,944 and references cited therein provide examples of such equipment.

Material-handling equipment usually includes components such as conveyors, rotary spreaders or the like. Actuators of material-handling equipment are typically powered by a hydraulic system or by a mixed hydraulic-pneumatic system. Power for the hydraulic system, including motors and actuators, is usually provided by a pulling vehicle via a power-take-off shaft mechanically coupled to a hydraulic power generator, a power pack within the material handling system or a separate modular power pack. Alternatively, hydraulic power may be provided via a hydraulic coupling from the pulling vehicle.

Material-handling equipment is controlled through operation of control elements such as switches, buttons, knobs, levers and touch screens or the like which may be grouped or integrated into a control console. The control elements are configured to be operated manually by a user to operate the typically hydraulic or pneumatic actuators to provide control over the actuator system of the material handling equipment. The control elements are usually either directly affixed to the material handling equipment or the control console is configured as a separate modular component operatively connected to the material handling equipment via a cable or umbilical cord to provide wired control of the equipment. Control elements, specifically in older equipment, are sometimes exclusively directly manually operated hydraulic valves. More recent systems include electrical switches operatively connected to electromagnetically-controlled hydraulic or pneumatic valves. Console-controlled hydraulic systems typically include electromagnetically controlled hydraulic valves.

Different material handling equipment is typically tailored towards different applications. In certain applications material may be disposed to within about a 20 foot range from the material-handling equipment. Disposal may be in different directions relative to the material-handling equipment including rearwards or below, for example. It is usually desirable for the operator to keep track of and to retain control of the material disposition while being outside of the disposal range. When the operator moves around, control of the material handling equipment by hard-wired or even cable-wired consoles may be cumbersome and ineffective.

Therefore there is a need for a new remote-controllable material handling system that provides at least some benefit over known systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a remote controllable material handling system. In accordance with an aspect of the present invention there is provided a remote controllable material handling system for particulate matter, said material handling system comprising a material handling device configured to carry the particular matter, said material handling device including one or more actuators operatively coupled thereto, said one or more actuators configured to transfer the particulate matter carried by the material handling device, the one or more actuators responsive to one or more control signals; a MHD receiver operatively connected to the material handling device, said MHD receiver configured to generate the one or more control signals in response to one or more transmission signals; and a wireless remote transmitter moveable relative to the material handling device, said wireless remote transmitter configured to receive as input one or more operator instructions and generate the one or more transmission signals for transmission to the MHD receiver in response to the one or more operator instructions.

### BRIEF DESCRIPTION OF THE FIGURES

FIG. 1 schematically illustrates a remote controllable material handling system according to one embodiment of the present invention.

FIG. 2 illustrates a material handling device for use with a material handling system according to one embodiment of the present invention.

FIG. 3 illustrates a block diagram of a remote electromagnetically controlled hydraulic system according to one embodiment of the present invention.

### DETAILED DESCRIPTION OF THE INVENTION

### Definitions

The term “particulate matter” is used to define types of fluid or granular particle based material that is capable of free flowing under its own weight in clumped, baked together, sunken or at least loosened or liquefied bulk configurations. Particulate matter may comprise particles such as chips or pellets, powder, grit, pebbles, gravel, rubble, ballast, crushed or broken solids or other format as would be readily understood. Particulate matter may be an organic or inorganic material including grain, wood, fertilizer, seed, soil, peat, sand, rock, stone or other matter, or combination thereof, as would be readily understood by a worker skilled in the art. Particulate matter may include dry, moist or a wet form of matter as well as liquid matter such as sludge or the like, for example. Furthermore, liquid associated with particular matter may be aqueous or otherwise as would be readily understood by a worker skilled in the art.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a remote-controllable material handling system, which comprises a material handling device (MHD) configured to carry particulate matter. The material handling device includes one or more operatively coupled actuators, wherein the one or more actuators are configured to control transfer of particulate matter carried by the material handling device. The one or more actuators are configured to be responsive to one or more control signals. The remote-controllable material-handling system further comprises a MHD receiver operatively connected to the material handling device, wherein the MHD receiver is configured to generate the one or more control signals in response to one or more transmission signals. Moreover, the remote-controllable material handling system comprises a wireless remote transmitter or transceiver moveable relative to the material handling device, wherein the wireless remote transmitter is configured to receive as input one or more operator instructions and generate the one or more transmission signals and transmit same to the MHD receiver in response to the one or more operator instructions.

According to an embodiment of the present invention an operator can operate the material handling system while being located outside of, for example, the disposal range of the particulate matter, or, if configured to be pulled by a pulling vehicle, optionally from within the pulling vehicle. The present invention also provides the operator with the ability to move relative to the material handling device during operation, while being able to retain visual contact with different parts of the material handling system, without being impeded by a wired connection with the material handling device.

According to one embodiment of the present invention, the remote-controllable material handling system can optionally be configured to, for example, take predetermined actions, respond with warnings, or cease functions that may endanger the operator during operation, when the operator remains or enters certain locations relative to the material handling device.

According to one embodiment of the present invention, the material handling system can comprise a MHD transmitter operatively connected to the material handling device in addition to the MHD receiver, or a MHD transceiver operatively connected to the material handling device in place of the MHD receiver. The optional MHD transmitter or MHD transceiver can provide the material handling device with the ability to additionally transmit signals to the remote control device rather than merely receive signals from the remote control device.

According to another embodiment of the present invention, the material handling system can further comprise a wireless remote receiver in combination with the wireless remote transmitter or a wireless remote transceiver in place of the wireless remote transmitter. The optional wireless remote receiver or wireless remote transceiver can provide the ability to additionally receive rather than merely transmit signals.

Different embodiments of the present invention may employ one or more MHD receivers, MHD transmitters or MHD transceivers in different combinations with one or more wireless remote transmitters, wireless remote receivers or wireless remote transceivers. It is noted that, while the terms MHD receiver and wireless remote transmitter are used in the following description, the scope of the description is intended to encompass transceivers or additional respective transmitters or receivers where technically feasible as would be readily understood by a worker skilled in the art.

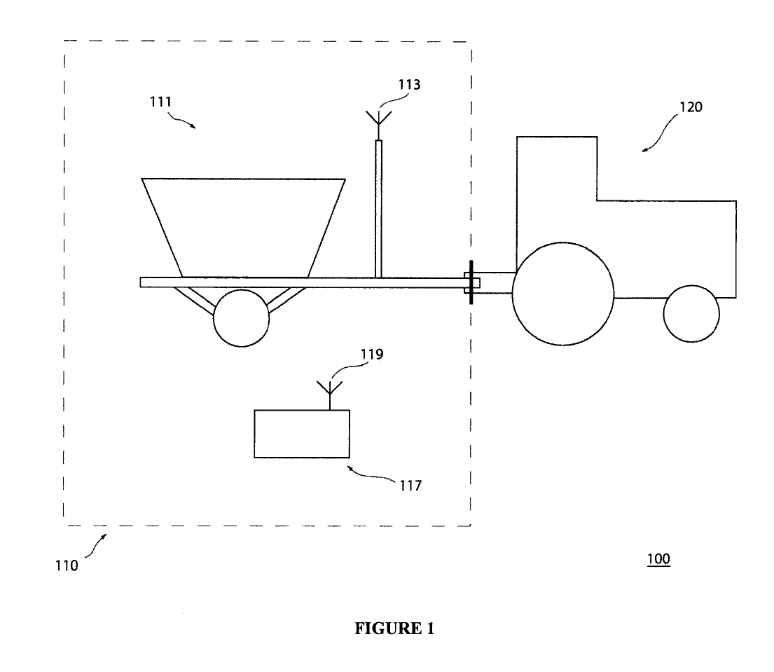

FIG. 1 schematically illustrates a material handling system 110 according to one embodiment of the present invention, wherein the material handling system is configured as a towed system, for example being towed by a vehicle 120, which can be configured as a tractor, truck or other towing vehicle as would be readily understood. The material handling system 110 comprises a material handling device 111 having a MHD receiver (not illustrated) with a receiver antenna system 113. The material handling system also comprises a wireless remote transmitter 117 with a transmitter antenna system 119. The receiver antenna system 113 and the transmitter antenna system 119 enable wireless remote control of the material handling device by an operator operating the wireless remote transmitter 117. Each of the receiver antenna system 113 and the transmitter antenna system 119 can comprise one or more antennas. The wireless remote transmitter 117 can be a console with one or more control elements such as buttons, sliders, pivotable control sticks, or other control elements, or a combination thereof, as would be readily understood by a worker skilled in the art.

According to an embodiment of the present invention, the material handling system can also be configured as a self propelled system and as such a towing vehicle may not be required in order to move the material handling system. A worker skilled in the art would readily understand how to configure the material handling system as a self propelled system.

### Material Handling Device (MHD)

According to an embodiment of the present invention, the material handling device may be configured as a vehicle trailer for use in combination with a pulling vehicle such as a tractor, for example, or it may be configured as an independent self-propelled vehicle. The material handling device comprises a number of actuators to enable reconfiguring of the material handling device, for example, lifting, reclining or rotating, certain components or attachments of the material handling device. The material handling device may be configured for the manipulation of particulate matter, for example. Control of the material handling device may include control of position and/or speed of actuation of the actuators, for example. Actuators of the material-handling device may also include drive systems such as motors or linear actuators for propelling conveyors, broadcasting spreaders, or the like for example.

According to embodiments of the present invention, the material handling device can be configured in a number of different ways and can include a number of different linear or rotational actuators (not illustrated). Each actuator may be controlled separately from the other actuators, or in combination with other actuators in order to provide the desired operation of the material handling device. For example, if a dump box is associated with the material handling device, an actuator on either side of the dump box may be required for the articulation of the dump box for particulate matter disposition for example. For purposes of controlling the material handling device, at least one degree of freedom associated with the material handling device may be controlled at a time during operation. The actuators associated with the material handling device may be powered in a number of different ways, for example, hydraulically, pneumatically, electrically, mechanically or other powered configuration or a combination thereof as would be readily understood by a worker skilled in the art.

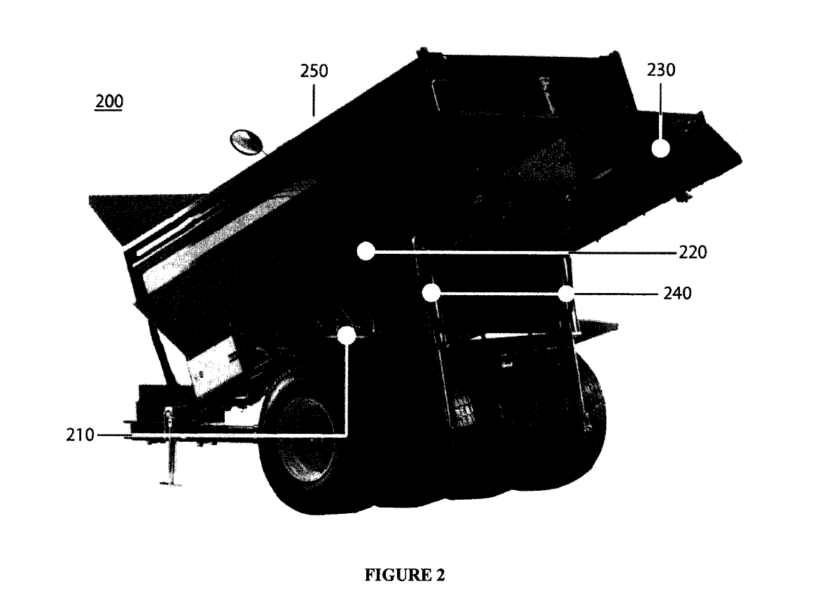

FIG. 2 illustrates an example of a material handling device 200. The material handling device 200 comprises a hopper 250 for holding particulate matter, a conveyor 230, and a pair of hydraulic cylinders 240. FIG. 2 also illustrates portions of hydraulic tubing 220 for providing hydraulic fluid to the hydraulically operated components such as the conveyor, and/or actuators, for example. The material handling device 200 comprises a built-in control console 210 which comprises a number of control elements including three levers for controlling the flow and distribution of hydraulic fluid.

FIG. 2 illustrates material handling device 200 in a configuration in which the hopper is reclined with hydraulic cylinders 240 expanded. The inclination of the hopper 250 can be varied within predetermined limits by retracting or expanding the hydraulic cylinders 240. The material-handling device 200 comprises a hitch for operatively attaching it to a pulling vehicle. The conveyor 230 can be used to assist disposition of particulate matter from the hopper 250 within a range of predetermined inclination angles. The conveyor 230 comprises an endless belt system for the transportation of particulate matter. The material handling device may be equipped with additional elements such as spreaders, broadcasters, additional conveyors or the like, for example. The additional elements may be modular and readily attachable or detachable to or from the material handling device.

The material handling device may optionally employ a position indicating device, a homing device or a positioning system, a global positioning system receiver, or the like for providing information about the location or position of the material handling device. The MHD may process and provide this information in an adequate form to an operator, for example, via the wireless remote transmitter. The material handling device may optionally transmit information about its location or position to or for reception by a remote or central MHD management system. This transmission may be performed via a transmitter or transceiver built into the material handling device. In embodiments of the present invention, a MHD management system can be computing device configured to collect information indicative of the one or more material handling systems associated therewith. This information may be utilized for deployment, maintenance or other tasks for each of the material handling systems.

According to one embodiment of the present invention, the material handling device is configured such that the actuators or other mechanisms associated therewith can be controlled by one or more control mechanisms directly connected to the material handling device. In this manner, the operator can control the operation of the material handling device directly or remotely or both.

### MHD Receiver and Wireless Remote Transmitter

The material handling system is configured for control over one or more actuators of the material handling device by means of a MHD receiver operatively connected to the material handling device. The MHD receiver is configured to be in wireless communication with a wireless remote transmitter under operating conditions. The material handling device may be exclusively controlled by the combination of the MHD receiver and the wireless remote transmitter or may further comprise secondary control mechanisms, for example, control levers or other devices associated with the material handling device.

Depending on the configuration of the MHD receiver and the wireless remote transmitter, the wireless communication range may extend to different distances between the MHD receiver and transmitter. A number of parameters can determine the communication range, for example, the bandwidths or range of bandwidths used for the wireless communication, the strength of the electromagnetic signal and the signal-to-noise ratio under operating conditions, and/or other parameters as would be readily understood by a worker skilled in the art. In addition, other nearby wireless equipment may affect the operation of the wireless control or reduce the wireless communication range, as would be known to a worker skilled in the art.

When one or more wireless control signals are received by the MHD receiver, the MHD receiver is configured to process the wireless control signals into electrical control signals which can be used for the actuation of one or more of the actuators associated with the material handling device. For example, the actuators may include or be used to operate electromagnetically actuated hydraulic valves, pressure valves electrical motors or other actuator control mechanism as would be readily understood by a worker skilled in the art.

According to an embodiment of the present invention, the MHD receiver comprises a computing device, for example, a microprocessor, a microcontroller or other computing device, which provides for the processing of the wireless control signals. The MHD receiver further comprises a memory, for example, ROM, RAM, EPROM, flash or other memory format as would be readily understood by a worker skilled in the art. The memory associated with the MHD receiver is accessible by the computing device associated with the MHD receiver, and can be used to store one or more instructions for the operation of the MHD receiver. The MHD receiver may receive power or other energy required for its operation from a power source directly and solely associated with the MHD receiver or from the material handling device or from a combination thereof.

According to one embodiment of the present invention, the material handling device includes one or more hydraulic actuators operatively coupled to corresponding hydraulic valves which comprise one or more paths for controlling the flow of hydraulic fluid to the actuators. The hydraulic actuators are actuated by either supplying or withdrawing adequate amounts of hydraulic fluid, wherein the valves can control the flow of hydraulic fluid. The actuators can be hydraulic motors, hydraulic cylinders or the like, for example, which can be used to configure, reconfigure, or operate components of the material handling device. The components of the material handling system may also alternatively or additionally or in part be operated mechanically, pneumatically or electrically.

According to an embodiment of the present invention, the wireless remote transmitter is configured to provide an operator with the ability to control one or more of the actuators associated with the material handling device. The wireless remote transmitter can be a console with one or more control elements such as buttons, sliders, pivotable control sticks, or other control elements or a combination thereof, as would be readily understood by a worker skilled in the art. These control elements are used by an operator in order to input desired operator instructions. The wireless remote transmitter is configured to generate one or more transmission signals in response to operator instructions. The transmission signals are transmitted wirelessly for receipt by the MHD receiver.

According to an embodiment of the present invention, the wireless remote transmitter comprises a computing device, for example, a microprocessor, a microcontroller or other computing device as would be readily understood by a worker skilled in the art, which provides for the processing of the operator instructions into the one or more wireless transmission signals. The wireless remote transmitter further comprises a memory, for example, ROM, RAM, EPROM, flash or other memory as would be readily understood by a worker skilled in the art. The memory can be accessed by the computing device and can be used to store one or more instructions or other operating code for the operation of the wireless remote transmitter. The wireless remote transmitter further includes a power source, for example, a battery or other source of power, which provides a means for operation thereof.

The remote controllable material-handling system may utilize electromagnetic radiation of different wavelengths commonly known in the art for communication of wireless control signals between the MHD receiver and the wireless remote transmitter. For example the wireless control signals can be configured using protocols including Bluetooth, IEEE 802.11, Wi-Fi, RF, a priority communication protocol or other communication protocol as would be readily understood by a worker skilled in the art.

According to an embodiment of the present invention, the communication protocol can be configured to allow control of the material handling device only upon authorization. This configuration of the communication protocol can prohibit inadvertent control of a material handling device by other transmitters. According to an embodiment of the present invention, the MHD receiver can be configured to cause further action only upon completion of an authorization procedure. An authorization procedure can be based on exchange of authorization codes including unique equipment identifiers or passwords, for example, that are compared against one or more authorized codes. Authorization in material handling systems according to different embodiments of the present invention can be configured differently. For example, an authorization can take place upon activation of the material handling system, or every time a user/operator instruction is received by the MHD receiver, for example.

Upon authorization of wireless control between the wireless remote transmitter and the MHD receiver, subsequent wireless signals can be encoded or otherwise encrypted, for example using an encryption key, in order to provide a desired level of security. In one embodiment of the present invention, security and safety of transmissions may be enhanced by employing a frequency hopping pattern which may be used by both the MHD receiver and wireless remote transmitter. The frequency hopping pattern can be determined upon authorization. A worker skilled in the art would readily understand other manners in which secure wireless transmission between the MHD receiver and the wireless remote transmitter may be employed.

According to one embodiment of the present invention, the communication control can also be configured to improve operator safety. For example, the material-handling system may stop, cease or prohibit the execution of reconfigurations or commands when the MHD receiver looses connection with the wireless remote transmitter. In one embodiment, the loss of connection can materialize as a loss of receipt by the MHD receiver of a beacon signal emitted by the wireless remote transmitter, for example.

According to one embodiment of the present invention, the remote controllable material handling system may be configured to provide the operator with the ability to automatically configure or reconfigure one or more degrees of freedom of the material handling device simultaneously in a predetermined way by providing the material handling system with one or more preset configuration instruction sets for operation thereof. This way, the operator may be required to submit one or more instructions via the wireless remote transmitter to the MHD receiver in order that the material handling device performs a simple or complex reconfiguration thereof in response to the one or more instructions, without the otherwise time-consuming requirement for the operator to interact with the control elements for the full duration of the reconfiguration.

According to one embodiment of the present invention, one or more preset configuration instruction sets are stored in memory associated with the wireless remote transmitter. A preset configuration instruction set can include one or more instructions which can result in the generation of one or more transmission signals for sending to the MHD receiver. For example, a single operator input can be input into the wireless remote transmitter, which results in a plurality of transmission signals being sent to the MHD receiver. The wireless remote transmitter can receive the input signal and subsequently access the memory associated therewith which can define the plurality of transmission signals or parameters relating to the generation thereof by the wireless remote transmitter. In one embodiment, a preset configuration can be representative of time dependent transmission of signals to the MHD receiver.

According to one embodiment of the present invention, one or more preset configuration instruction sets are stored in memory associated with the MHD receiver. A preset configuration instruction set can include one or more instructions which can result in the generation of one or more control signals for controlling the one or more actuators associated with the material handling device. For example, a single transmission signal can be received by the MHD receiver, which results in a plurality of control signals being generated for control of one or more of the actuators. The MHD receiver can receive the transmission signal and subsequently access the memory associated therewith which can define the plurality of control signals or parameters relating to the generation thereof by the MHD receiver. In one embodiment, a preset configuration can be representative of time dependent control signals for controlling the material handling device over a period of time.

According to one embodiment of the present invention, the wireless remote transmitter or the MHD transmitter or both, may be configured to enter a preset-configuration mode which may be activated by an operator and can provide a means for entering new preset configurations or for altering preexisting preset configurations via the wireless remote transmitter, the MHD receiver or both.

According to one embodiment of the present invention, a particular wireless remote transmitter can be configured to provide control of multiple material handling devices. This can be enabled by a security authorization or other means for secure access to a MHD receiver, each associated with one of the material handling devices.

According to one embodiment of the present invention, the material handling system may also include detectors or sensors providing indications about the position of, or the speed or rate at which one or more actuators move or rotate. In addition, further environmental detectors or sensors may be employed to sense the environment of the material handling device for obstacles, persons, other objects or the like. Environmental detectors or sensors may include a number of different types of sensors, for example, ultrasound, radar or optical sensors or other sensor configuration as would be readily understood by a worker skilled in the art.

According to one embodiment of the present invention, the material handling system may use and process information obtained from one or more environmental detectors or sensors in order to initiate predetermined actions, for example, the suppression, stop or cease of an action that might otherwise impose a threat to the immediate surroundings or harm nearby persons, objects or the material handling system.

According to one embodiment of the present invention, the material handling system can be further configured to provide self-diagnostic functions including determining an instant configuration of the material handling system or one or more of its components. Self-diagnostic functions may also include the execution of self tests to determine the degree of functionality of the material handling system or one or more of its components.

According to one embodiment of the present invention, the MHD receiver may be complemented with a MHD transmitter or replaced by a MHD transceiver. Likewise, the wireless remote transmitter may be complemented with a wireless remote receiver or replaced by a wireless remote transceiver. As is known, the receiver portion of a transceiver can provide functionality provided by a corresponding standalone receiver. Likewise, the transmitter portion of a transceiver can provide functionality provided by a corresponding standalone transmitter. According to the present invention, different embodiments may employ different combinations of one or more receivers, transmitters or transceivers.

According to one embodiment of the present invention, the wireless remote transmitter or the material handling device or both can comprise a position indicating device, a homing device or a positioning system, for example, a global positioning system receiver, for providing information about the location or position of the material handling device or the wireless remote transmitter. The wireless remote transmitter may process this information and provide it in an adequate form to an operator, for example, via an adequate user interface in or attached to the wireless remote transmitter. The wireless remote transmitter may optionally transmit information about its own location or position or that of the material handling device to or for reception by a remote or central MHD management system. This transmission may be performed via the built-in transmitter or transceiver or the transmitter or transceiver built into the MHD.

The invention will now be described with reference to a specific example. It will be understood that the following examples are intended to describe embodiments of the invention and are not intended to limit the invention in any way.

### Example

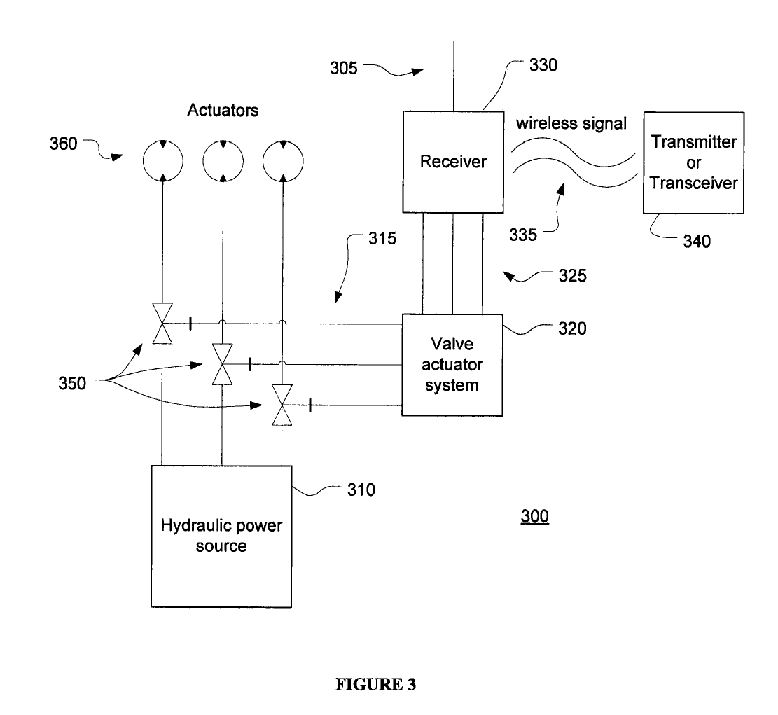

FIG. 3 illustrates a block diagram of an example wireless remote-controllable hydraulic system 300 for use with a material handling system according to an embodiment of the present invention. The example remote-controllable hydraulic system 300 comprises a transmitter 340, a receiver 330, valve actuator system 320, hydraulic valves 350, a hydraulic power source 310 and hydraulic actuators 360. Transmitter 340 and receiver 330 can be operatively connected 335 via electromagnetic signals. Receiver 330 and valve actuator system 320 are operatively connected, for example, via an adequate number (three as illustrated) of wires 325. Valve actuator system 320 and hydraulic valves 350 are adequately electrically or mechanically or electromechanically connected 315.

Transmitter 340 and receiver 330 may be used in the wireless remote transmitter and MHD receiver of a material handling system. Under operating conditions, the receiver 330 obtains electrical power via connection 305 from a suitable electrical power source (not illustrated). The hydraulic power source 310 may be internal or external and may require a suitable other source of power. The hydraulic power source 310 may be provided in a number of different ways as described, for example, by a pulling vehicle. While the example system of FIG. 3 illustrates a system including three hydraulic actuators, it is noted that other example systems may comprise three or other numbers of hydraulic actuators, other numbers of wires, valves, or mechanical or electrical interconnections.

According to one embodiment of the present invention, the remote wireless controlled hydraulic system generally works as follows. When an electromagnetic signal, for example, a radio signal, that encodes an adequate instruction is transmitted by transmitter 340 and received by receiver 330, receiver 330 generates corresponding electrical signals 325 for the operation of the valve actuator system 320, which in turn operate corresponding hydraulic valves 350. As is readily known, the valve actuator system may comprise electromechanical components and comprise motors or solenoids for operating the valves and providing a valve-opening and valve-losing function. It is noted that different embodiments of the present invention may employ hydraulic valves different from the illustrated single-path hydraulic valves 350.

Hydraulic power source 310, for example, a suitably powered pump that can provide hydraulic fluid from and to a corresponding reservoir, can maintain a predetermined pressure of the hydraulic fluid and hydraulic fluid flow within predetermined ranges during operating conditions, and thereby can provide hydraulic power to the actuators 360 via the hydraulic valves 350. Depending on the open or closed state of the hydraulic valves 350, hydraulic fluid is supplied to corresponding hydraulic actuators 360, which may be employed in the material handling device resulting in a desired reconfiguration of the material handling device.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A remote controllable material handling system for particulate matter, said material handling system comprising:
(a) a material handling device (MHD) configured to carry the particulate matter, said material handling device including one or more actuators operatively coupled thereto, said one or more actuators configured to transfer the particulate matter carried by the material handling device, the one or more actuators responsive to one or more control signals;
(b) a MHD receiver operatively connected to the material handling device, said MHD receiver configured to generate the one or more control signals in response to one or more transmission signals; and
(c) a wireless remote transmitter moveable relative to the material handling device, said wireless remote transmitter configured to receive as input one or more operator instructions and generate the one or more transmission signals for transmission to the MHD receiver in response to the one or more operator instructions.

2. The remote controllable material handling system according to claim 1, further comprising one or more first sensors operatively coupled to the one or more actuators and the MHD receiver, the one or more first sensors configured to provide one or more first sensor signals indicative of configuration of the material handling device, and wherein the MHD receiver is configured to use at least in part the one or more first sensor signals during generation of the one or more control signals.

3. The remote controllable material handling system according to claim 2, wherein at least one of the first sensor signals is indicative of the configuration of at least one of the actuators.

4. The remote controllable material handling system according to claim 2, wherein at least one of the first sensor signals is indicative of rate of change of configuration of at least one of the actuators.

5. The remote controllable material handling system according to claim 1, further comprising one or more second sensors operatively coupled to the MHD receiver, the one or more second sensors configured to provide one or more second sensor signals indicative of conditions of a environment external to the material handling device to the MHD receiver, and wherein the MHD receiver is configured to use at least in part the one or more second sensor signals during generation of the one or more control signals.

6. The remote controllable material handling system according to claim 5, wherein at least one of the second sensor signals is indicative of a distance between the material handling device and the wireless remote transmitter.

7. The remote controllable material handling system according to claim 5, wherein at least one of the second sensor signals is indicative of a global position of at least one of the second sensors.

8. The remote controllable material handling system according to claim 5, wherein at least one of the second sensor signals is indicative of a global position of the wireless remote transmitter.

9. The remote controllable material handling system according to claim 1, wherein the one or more actuators are hydraulically operated.

10. The remote controllable material handling system according to claim 9, wherein a hydraulic power source is external to the material handling system.

11. The remote controllable material handling system according to claim 1, wherein the MHD receiver is configured to detect a loss of operative connection with the wireless remote transmitter, and wherein the MHD receiver is configured to stop operation of the one or more actuators upon loss of operative connection with the wireless remote transmitter.

12. The remote controllable material handling system according to claim 1, wherein the MHD receiver is configured to detect a loss of operative connection with the wireless remote transmitter, and wherein the MHD receiver is configured to control operation of the one or more actuators upon loss of operative connection with the wireless remote transmitter, so that the material handling device assumes a predetermined configuration.

13. The remote controllable material handling system according to claim 1, wherein the MHD receiver is configured to respond to the wireless remote transmitter only upon authorization of the wireless remote transmitter with the MHD receiver.

14. The remote controllable material handling system according to claim 13, wherein the authorization comprises transmission and verification of one or more authorization codes between the MHD receiver and the wireless remote transmitter.

15. The remote controllable material handling system according to claim 13, wherein the one or more authorization codes include a first identifier assigned to the MHD receiver and a second identifier assigned to the wireless remote transmitter, and verification includes a comparison of the first identifier with the second identifier in the MHD receiver.

16. The remote controllable material handling system according to claim 13, wherein the authorization takes place at a predetermined event.

17. The remote controllable material handling system according to claim 16, wherein the predetermined event corresponds to activation of the material handling device.

18. The remote controllable material handling system according to claim 16, wherein the predetermined event corresponds to receipt of each one of the operator instructions via the one or more transmission signals.

19. The remote controllable material handling system according to claim 1, wherein the wireless remote transmitter comprises one or more preset configuration instruction sets.

20. The remote controllable material handling system according to claim 1, wherein the MHD receiver comprises one or more present configuration instructions sets.
